(19) United States
(12) Patent Application Publication
(10) Pub. No.: US 2011/0205572 A1
(43) Pub. Date: Aug. 25, 2011

(54) IMAGE PROCESSING APPARATUS, IMAGE PROCESSING METHOD, AND RECORDING MEDIUM

(75) Inventor: Naoki Tsuchitoi, Kawasaki-shi (JP)

(73) Assignee: CANON KABUSHIKI KAISHA, Tokyo (JP)

(21) Appl. No.: 13/012,251

(22) Filed: Jan. 24, 2011

(30) Foreign Application Priority Data
Feb. 24, 2010 (JP) 2010-038826

(51) Int. Cl. H04N 1/04

(52) U.S. Cl. 358/1.14

(57) ABSTRACT

More complex processing control is performed based on a plurality of image codes included in an original document. An image processing apparatus wherein if an analysis result of a first image code included in the original document includes information indicating scanning prohibition, a second image code included in the original document is analyzed, and wherein if an analysis result of the second image code includes information indicating conditional scanning prohibition, scanning of the original document is permitted in accordance with the condition.

### BACKGROUND OF THE INVENTION

1. Field of the Invention

The present invention relates to an image processing apparatus, an image processing method, and a recording medium.

2. Description of the Related Art

QR codes have been widely used as image codes for printing information encoded and converted into an image onto media, such as paper. QR codes can be detected by a very large number of devices, and there also exist devices that can detect only the QR codes as the image codes. In addition, a QR code can include information indicating that copying of an original document on which the QR code has been printed is permitted or prohibited. However, since the QR code is small, if trying to copy the original document with a portion of the QR code being hidden, it can be copied. Consequently, each vendor has developed a technology in which encoded information is combined as dots over a whole surface of the original document. For example, a technology of Low Visibility Barcode (LVBC) is included in the above. This LVBC can include conditional permission information in addition to copying permission/prohibition.

LVBCs and QR codes are in a relation that complements mutual disadvantages. Namely, although QR codes are standardized standard codes, and can be detected by a number of devices, a copying-prohibited original document can be copied by hiding a QR code including copying prohibition information. In contrast with this, although devices that can detect LVBCs are limited, the copying-prohibited original document is not copied even though an LVBC is hidden. In addition, the LVBC can include detailed information of conditional permission. Consequently, it can be considered to print these two codes on a piece of original document.

Here will be considered a case where an original document is printed on which an LVBC indicates conditional permission and a QR code indicates copying-prohibited. In such case, when trying to copy this original document with a non-LVBC-compliant device, it can be copied. This would never be conditional permission. Namely, when only one image code is used, processing cannot be performed on a condition that cannot be included in the image code.

### SUMMARY OF THE INVENTION

An object of the present invention is to provide an image processing apparatus, an image processing method, and a recording medium which control more complex processing based on a plurality of image codes included in an original document.

An image processing apparatus according to the present invention includes: a unit configured to analyze a first image code included in an original document; a unit configured to determine whether or not an analysis result of the first image code includes information indicating scanning prohibition; a unit configured to analyze a second image code included in the original document if the analysis result of the first image code includes the information indicating scanning prohibition; and a unit configured to permit scanning of the original document in accordance with a condition if an analysis result of the second image code includes information indicating the conditional scanning prohibition.

According to the present invention, there can be provided an image processing apparatus, an image processing method, and a recording medium which control more complex processing based on a plurality of image codes included in an original document.

Further features of the present invention will become apparent from the following description of exemplary embodiments (with reference to the attached drawings).

### BRIEF DESCRIPTION OF THE DRAWINGS

FIG. 1 is a block diagram of an MFP in a first embodiment;

FIG. 2 is a flowchart showing an operations outline of the MFP in the first embodiment at the time of printing;

FIG. 3 is a complementary diagram for illustrating a unit barcode;

FIG. 4 is a diagram illustrating correction of a grid rotation angle;

FIG. 5 is a diagram showing one example of arrangement of a region in which information is embedded;

FIG. 6 is a table showing a format of data stored as a QR code, the format being defined by JBMIA;

FIG. 7 is a flow chart illustrating operations of an information formation control section; and

FIG. 8 is a schematic view of an original document in which information has been embedded.

### DESCRIPTION OF THE EMBODIMENTS

Hereinafter, best modes for carrying out the present invention will be described using drawings.

### First Embodiment

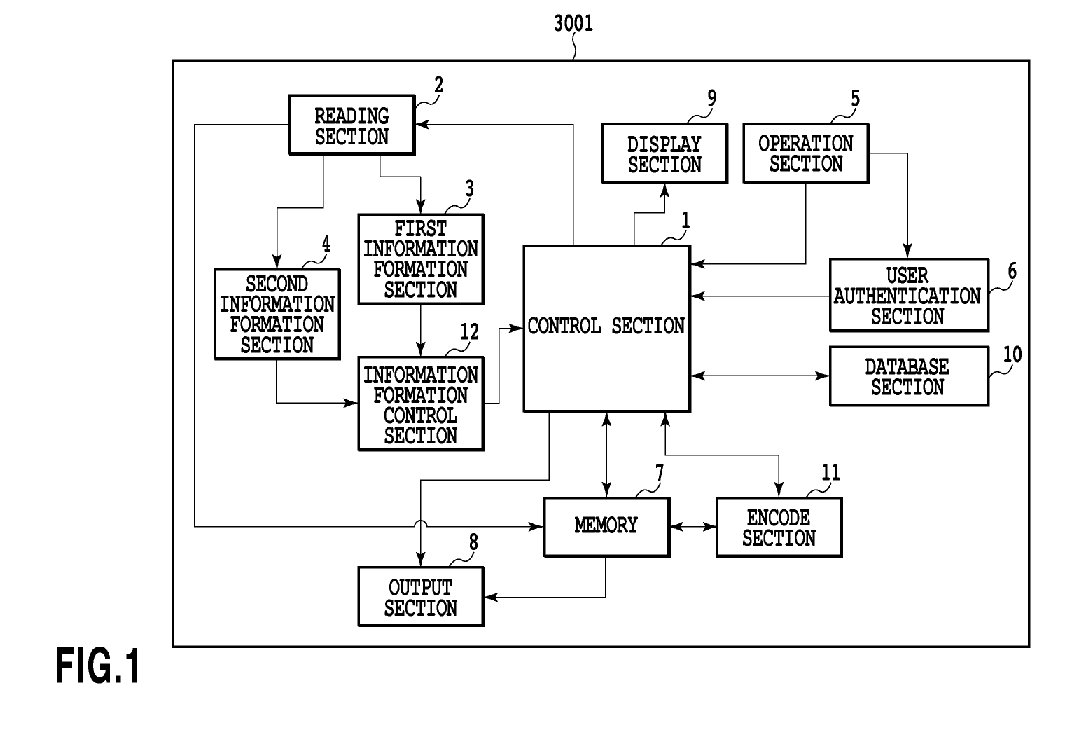

FIG. 1 is a block diagram showing a configuration of an MFP3001 as one example of an image processing apparatus in the present embodiment.

A control section 1 controls each of components of the MFP3001. An operation section 5 receives operation and an input from a user, and transmits a control signal to the control section 1. A user authentication section 6 manages authentication of the user who uses the MFP3001. A reading section 2 scans an original document, and generates document information. A first information formation section 3 obtains embedded information by decoding coded first embedded information (for example, a QR code) included in the document information. A second information formation section 4 obtains embedded information by decoding coded second embedded information (for example, an LVBC) included in the document information. An information formation control section 12 performs a predetermined determination processing depending on processing results obtained from the first information formation section 3 and the second information formation section 4, and controls scan processing of the original document etc. A memory 7 stores the document information obtained by scanning. After reading image information from the memory 7, an output section 8 prints the image information or transmits it to an external device. Here, the external device refers to a PC etc. that are connected to the MFP3001 through a network. A display section 9 displays a screen by control of the control section 1. A database 10 records settings and logs of the MFP3001. An encode section 11 generates embedded information by encoding output control information and tracking information (at this time, as described later, these pieces of information are encoded after error correction codes are added), and generates a barcode by converting the embedded information to an image.

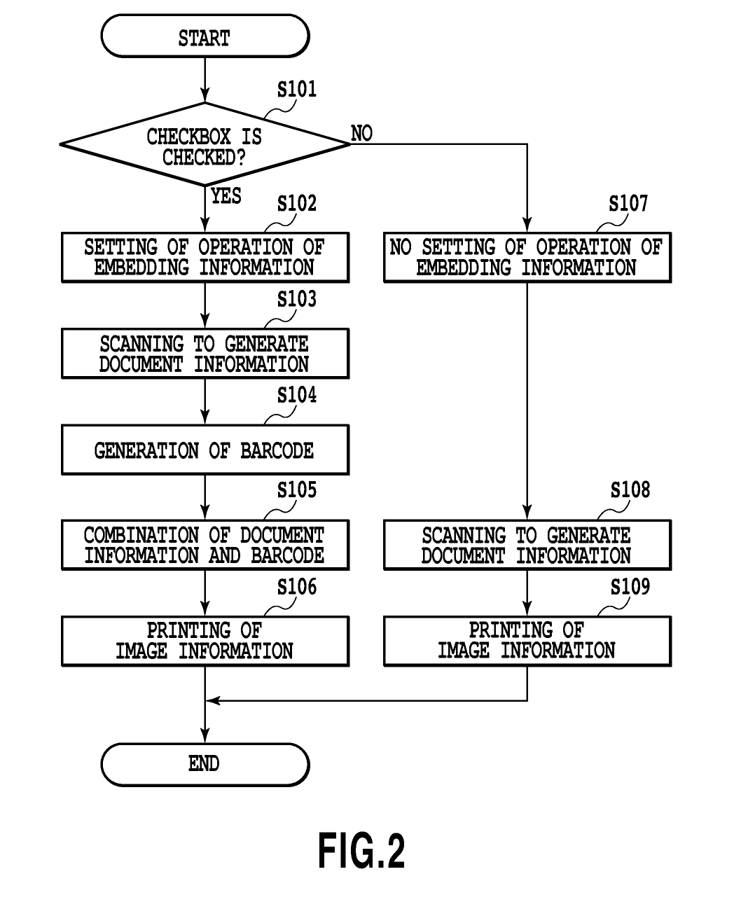

Hereinafter will be described a flow of processing performed in each block of the MFP3001 before embedded information to be embedded in document information is generated to be printed with reference to FIGS. 1 and 2.

First, a user inputs user ID/password into the operation section 5 while looking at a setting screen displayed on the display section 9.

The input information is sent from the operation section 5 to the user authentication section 6, and the user authentication section 6 determines whether or not the input password is an appropriate one. If it is determined that the password is the appropriate one, the user authentication section 6 informs the control section 1 of the determination result and the user ID.

After that, the control section 1 displays on the display section 9 a screen for setting whether or not coded information is embedded in the document information. For example, the control section 1 displays on the display section 9 a checkbox for “embed the information”.

Subsequently, when the user checks the checkbox through the operation section 5, and thereby instructs to embed information and to print, the operation section 5 transmits a control signal to the control section 1 depending on the instructions. It is to be noted that the instruction to embed information may be performed from a driver or a utility of a PC connected to the MFP3001.

In addition, if the instruction to embed information is not received from the user (for example, if the checkbox is not checked), the operation section 5 transmits to the control section 1 an instruction to print without embedding information.

After that, as shown at step S101 in FIG. 2, the control section 1 determines whether or not the checkbox is checked (i.e., whether or not the instruction to embed information is received). If the instruction to embed information is received, the process proceeds to step S102, and if not, proceeds to step S107.

At step S102, the control section 1 sets an operation to embed information, and informs the encode section 11 of the setting and the above-described user ID. The control section 1 then commands the reading section 2 to scan the printed matter (original document).

At step S103, the reading section 2 generates the document information by scanning the printed matter, and then transmits it to the memory 7 and the information formation section 3.

At step S104, the encode section 11 obtains an encoded result (embedded information) by encoding copying prohibition information and tracking information (including the user ID), and generates an image code (for example, a barcode, a QR code, an LVBC, etc.) by converting the embedded information into an image. Here, a first embedded information and a second embedded information, which will be described hereinafter, are encoded, respectively to generate a first image code (first information embedding) and a second image code (second information embedding). The generated image codes are then transmitted to the memory 7. Subsequently, if the control section 1 detects that the memory 7 has received the image codes and the document information, the process proceeds to step S105.

At step S105, image information is generated by combining the image codes and the document information in the memory 7.

It is to be noted that although two types of image codes are generated at step S104, and these image codes are combined with the document information at step S105 in the present embodiment, the present invention is not limited to this method. For example, three or more types of image codes may be generated to combine with the document information. In addition, one or more image code(s) may be previously included in the document information scanned at step S103, and one type of image code may be generated at step S104.

At step S106, the generated image information is transmitted from the memory 7 to the output section 8, and the image information is printed by the output section 8.

Note that if it is determined at step S101 that the instruction to embed information has not been received, the control section 1 commands the reading section 2 to scan the printed matter without setting the operation of embedding information at step S107.

At step S108, the reading section 2 generates the document information by scanning the printed matter, and transmits it to the memory 7.

Subsequently, if the control section 1 detects that the memory 7 has received the document information, the process proceeds to step S109. The control section 1 transmits the document information as the image information from the memory 7 to the output section 8, and makes the output section 8 print it.

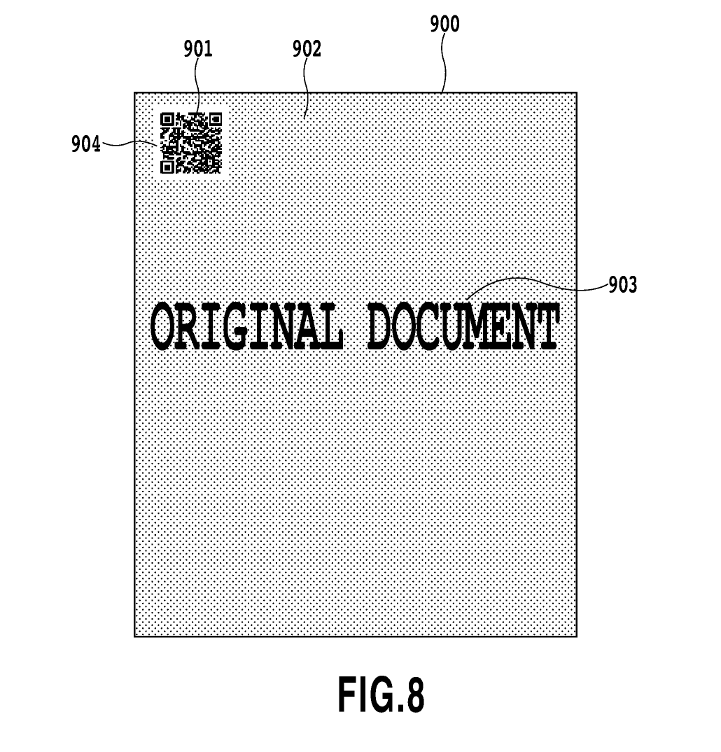

FIG. 8 is a schematic view of the original document in which information has been embedded by the processing shown in FIG. 2.

Two types of information embedding are made in this original document. In the present embodiment, in an original document 900, embedded are a first information embedding 901, which is a QR code defined by JBMIA, and a second information embedding 902, which is an image code uniquely defined by a manufacturer.

It is to be noted that respective regions of the first information embedding 901 and the second information embedding 902 are defined to be partitioned by a blank region 904 (quiet zone) of a constant size so as not to confuse them. Reference numeral 903 denotes characters originally included in the original document.

The first information embedding 901, i.e., the QR code has a feature of not having a region for a unique code of a manufacturer since it is a manufacturer-independent standard.

In addition, there is a feature in the second information embedding 902 that codes can be freely added thereto, but that it is incompatible between manufacturers since it is uniquely defined by the manufacturer.

It is to be noted that the above-described tracking information includes useful information to identify a printer, for example, information such as a printing date, a user name (i.e., user ID) of a user who instructed to print, and a device name. The tracking information herein is defined as information that can be used to identify the printer.

Hereinafter will be described the details of the embedded image codes (information embedding).

Since a method for embedding the QR code, which is the first information embedding 901, has been well-known, description thereof will be omitted here.

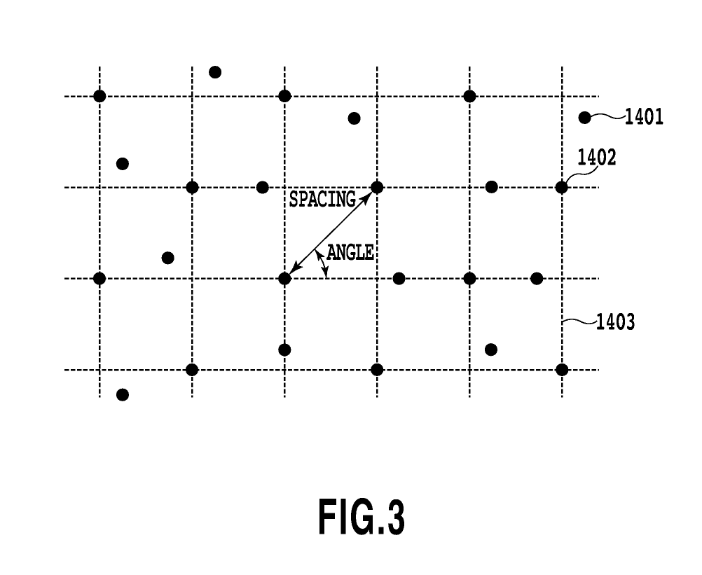

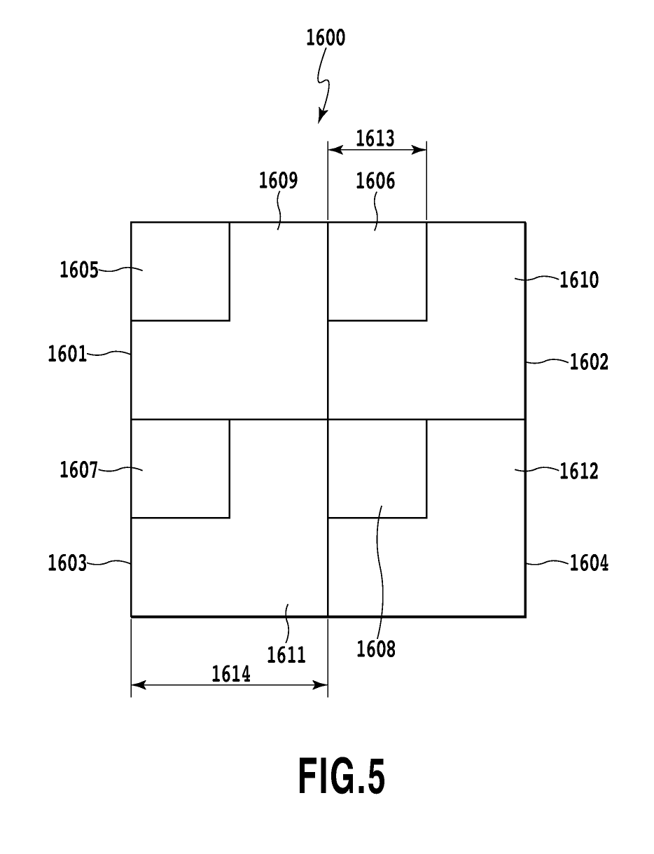

Next, regarding the second information embedding 902, there will be described one example of a method for encoding prohibition information and tracking information to then convert the encoded result to an image using FIGS. 3 and 5.

FIG. 5 is a complementary diagram for illustrating a unit barcode 1600. The unit barcode 1600 is approximately a square centimeter, and it is comprised of a high density region (1605 to 1608) and a low density region 1609 to 1612. The encoded result of the prohibition information will be included in this high density region, and that of the tracking information will be in the low density region.

It is to be noted that a large amount of error correction codes is used in the high density region compared with the low density region (there is an idea in it that the prohibition information is more important than the tracking information). Note that it is because a data size of the prohibition information is smaller than the tracking information that the region where the prohibition information is included is smaller although the large amount of error correction codes is used therein.

It is to be noted that this unit barcode 1600 will be repeatedly combined with the whole surface of the document information. For example, when the document information is printed on a sheet of A4 size (21 cm×29.7 cm), only 21×29 unit barcodes will be combined with the document information. As a result of this, 609 pieces of the same information will be combined.

Herein, all the unit barcodes (609 unit barcodes) or a part thereof that are combined with the document information are referred to as barcodes (or image codes).

FIG. 3 is a diagram showing an example of what kind of dots are included in a region 1605 shown in FIG. 5. Information dots 1901 and alignment dots 1402 are included in this region 1605.

The alignment dots 1402 exist at regular intervals on reference grids 1403 indicated with a dotted line (i.e., on intersections between the reference grids 1403).

Information dots then exist at positions deviated from the intersections between these reference grids 1403.

The encoded result of the prohibition information is represented with this deviated directions (deviated directions of the deviated positions with respect to the intersections).

In other words, when (the encoded result of the prohibition information, which is a part of) the embedded information obtained by encoding the prohibition information is converted into an image, created is a unit barcode that includes the information dots 1401 and the alignment dots 1402 in the region 1606.

The same dots obtained by converting the same information into an image with the same method are included also in the other regions 1606 to 1608 (in order to keep redundancy).

It is to be noted that although the dots obtained by converting (the encoded result of the tracking information, which is a part of) the embedded information into an image are included in the regions 1609 to 1612, a technique to convert information into an image is the same as that in the case of the regions 1605 to 1608.

It is to be noted that all the following processing is referred to as encoding herein: (i) prohibition information and/or tracking information are/is encoded to be embedded information; (ii) unit barcodes are created by converting this embedded information into an image; and (iii) the unit barcodes (for example, 609 pieces of unit barcodes) are arranged vertically and horizontally. It is the encode section 11 that performs encoding.

Incidentally, although the above-described reference grids are drawn with the dotted line in FIG. 3, they are not actually printed.

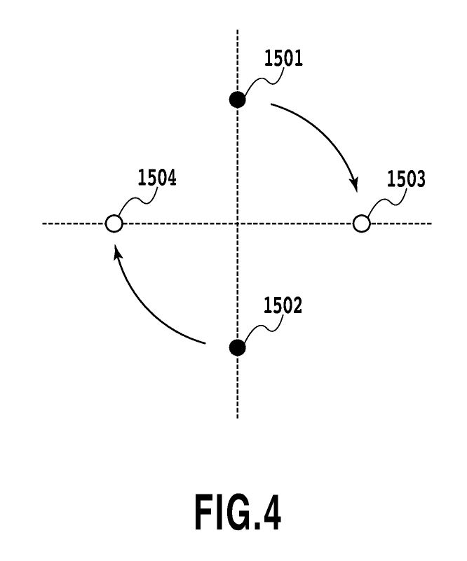

How to find out this virtual line will be described using FIG. 4. This is processing performed by the first information formation section 3 or the second information formation section 4. Hereinafter, the processing performed by the first information formation section 3 will be described as an example.

First, the first information formation section 3 selects an arbitrary dot 1501. The first information formation section 3 then selects an arbitrary dot 1502 that exists around the selected dot. Subsequently, the first information formation section 3 rotates positions of these selected dots by 90 degrees with the center point of the both dots being a center.

If dots exist at the positions obtained by rotation, the first information formation section 3 determines that the above-described each selected dot is an alignment dot that should exist at regular intervals vertically and horizontally.

Meanwhile, if the dots do not exist at the positions obtained by rotation, the first information formation section 3 determines that the each selected dot is an information dot that should exist at a random position. In a manner described above, the first information formation section 3 finds out two alignment dots, and then finds out all the other alignment dots utilizing a constraint that the alignment dots exist at regular intervals vertically and horizontally.

After finding out all the alignment dots, the first information formation section 3 virtually draws reference grids on these alignment dots, and finally calculates deviated directions of the remaining dots (i.e., information dots) from the intersections between the reference grids to thereby obtain embedded information.

It is to be noted that information is obtained as follows herein: if the information dots are deviated in an upper direction, embedded information indicates zero; if deviated in an upper right direction, it indicates one; if deviated in a right direction, it indicates two, and . . . .

Next, conditional prohibition information will be described.

Conditional prohibition information is identification information not only for permitting/prohibiting simple printing (or scanning, copying, etc.) of a document, but for permitting a specific user to print the document. For example, identification information, such as a password to authenticate an original document, and a user name for which printing is permitted, corresponds to the above information.

Since the conditional prohibition information is not defined by JBMIA, it cannot be represented with the first information embedding 901, i.e., the QR code, and thus it can be represented only using the second information embedding 902.

Hereinafter will be described conditional prohibition information using the second information embedding 902.

Although the encoded information of the prohibition information is included in the above-described high density region (1605 to 1608), it is possible to include a part of the conditional prohibition information in addition to the prohibition information. However, the above-described identification information cannot be included in the high density region since the region has a property to use a large amount of error correction codes by reducing a data size, and thus it is possible to achieve embedding the identification information by including it in the low density region (1609 to 1612).

There will be described an actual analyzing method of conditional prohibition information.

First, when a composite machine scans an original document, image data is output to an analysis section, where analysis of the low density region (1609 to 1612) is started. If the analysis result indicates permission, printing is continued, and if it indicates prohibition, printing is canceled, but if conditional prohibition is detected, analysis of the high density region (1605 to 1608) is followed. Password information is extracted from this analysis result, and then a password input screen is displayed on a user interface of the composite machine. If an input password matches the registered one, printing is continued, and if it does not match, printing is canceled.

By using above method, there have been achieved by various vendors not only simple permission/prohibition, but a print restriction function based on complex conditions, such as a password.

Meanwhile, a problem has been pointed out that there is no compatibility between vendors since they individually achieve their barcodes as described above.

Specifically, a problem has occurred where an original document with an image code created by a composite machine made by A company cannot be analyzed by a composite machine made by B company. In order to solve this problem, a standard using a common barcode has been planned by JBMIA.

According to this standard, print restriction is achieved using a QR code (Quick Response code, which is standardized in ISO/IEC18004). However, a specification for print restriction is limited in the standard of JBMIA so that any composite machine vendor can achieve print restriction.

For example, a size for which tracking information can be embedded is limited when embedding it, and further, there is no above-described print restriction function based on the complex conditions, such as the password, and only simple permission/prohibition are standardized.

The present invention proposes a method that can achieve a print restriction function based on complex conditions without departing from the standard of JBMIA.

Hereinafter, the method will be described.

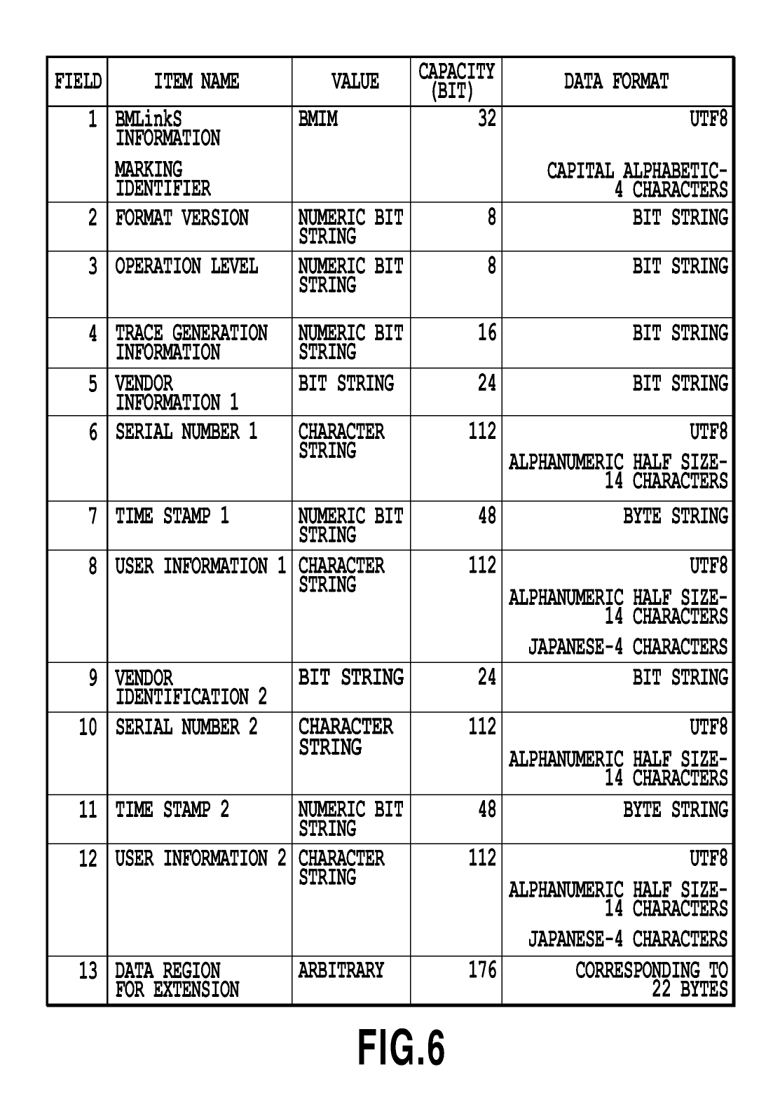

FIG. 6 is a table showing a format of data stored as QR codes, the format being defined by JBMIA. In FIG. 6, vendor information 1 to be stored in a field 5 and vendor information 2 to be stored in a field 9 are stored as 24 bits, i.e., 3 bytes of information, respectively.

Vendor-specific identification information defined by IEEE OUI (Organization Unique Identifier) is stored here.

For example, in a case of Canon (registered trademark) Inc., 00-00-85 (hexadecimal number) or 00-1E-8F (hexadecimal number) is allocated as vendor-specific information. Meanwhile, the above-described conditional prohibition information, such as a password cannot be represented in the table of FIG. 6.

Consequently, in the present embodiment, if a vendor-specific identification information is read, and thereby the information is recognized as a specified vendor's, information stored in the above-described high density region (1605 to 1608) is further tried to be analyzed. If conditional prohibition information can be then extracted as a result of the analysis, output control is performed in accordance with the condition.

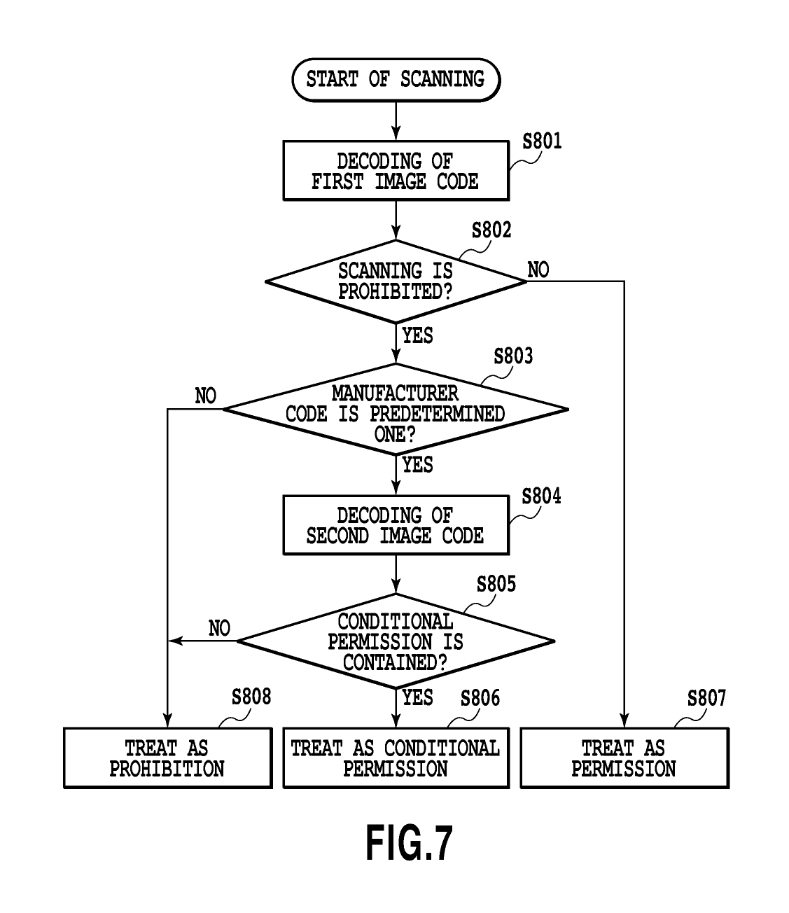

FIG. 7 is a flow chart illustrating operations of an information formation control section 12. Processing shown in FIG. 7 is started when the reading section 2 reads each page of an original document. This processing is executed by control of the control section 1 based on a control program stored in a storage section, such as the memory 7.

At step S801, the first information formation section 3 decodes the first image code (QR code) in the original document to obtain the first embedded information, and then analyzes the information. At step S802, the information formation control section 12 determines whether or not scanning prohibition information is included in the first embedded information. This determination is performed based on whether or not a value of a field 3 (operation level) in FIG. 6 is a value indicating scanning prohibition. A code indicating scanning permission or prohibition is included in the field 3, and no more extension is performed in view of the standard. Here, if a value corresponding to scanning permission is included, the process proceeds to step S807, and the target page in the original document is treated as the scanning-permitted one. Namely, output processing etc. of image information of the target page by the output section 8 is not performed. Meanwhile, if the value corresponding to scanning prohibition is included, the process proceeds to step S803.

At step S803, the information formation control section 12 determines whether or not the identification information of the vendor included in the first embedded information (refer to the field 9 in FIG. 6) is the one of the specified vendor that provides a function capable of responding to the conditional prohibition information. Namely, the information formation control section 12 determines whether or not information indicating a predetermined vendor is included in the first embedded information. For example, the identification information of the specified vendor is, not limited to this, previously stored in the storage section, such as the memory 7 or a database section 10. Determination at step S803 is performed by comparing the identification information of the vendor included in the first embedded information with the identification information of the specified vendor stored in the storage section of the MFP3001.

It is to be noted that determination at step S803 is not limited to this method. As a modified example, it may be determined whether or not information indicating whether or not processing at step S804, which will be described hereinafter, is performed is included in the first embedded information.

If the identification information of the vendor is determined to be other than the specified vendor's at step S803 (or if the information indicating that the processing at step S804 is performed is not included), the process proceeds to step S808, and the target page is treated as the scanning-prohibited one. In addition, if the identification information of the vendor is determined to be the specified vendor's (or if the information indicating that the processing at step S804 is performed is included), the process proceeds to step S809. At step S804, the second information formation section 4 decodes the second image code (for example, LVBC code) in the original document to obtain the second embedded information, and then analyzes the information. Namely, according to the present embodiment, subsequent processing for the image data read from the original document is switched depending on a determination result of whether or not the information indicating the predetermined vendor is included in the first embedded information of step S803.

Note that it is defined in the present embodiment that if the identification information of the vendor is determined to be the specified vendor's at step S803, the processing at step S804 is performed, but the present invention is not limited to this method. As a modified example, if determined as scanning prohibition at step S802, processing at step S804 may be performed without performing the determination processing at step S803.

At step S805, if the information formation control section 12 determines that the information indicating conditional scanning prohibition is included in the second embedded information, the process proceeds to step S806, and the target page is treated as the conditionally-prohibited one. Namely, output processing of the image information of the target page by the output section 8 is permitted in accordance with the specified condition. For example, the information formation control section 12 displays the password input screen on the display section 9, and determines scanning permission/prohibition based on the information input through the input screen. In addition, if conditional prohibition information is not found, the process proceeds to step S808, and the target page in the original document is treated as the scanning-prohibited one.

As described above, by changing the control depending on the identification information of the vendor, it becomes possible to detect that conditional prohibition information has been embedded with another embedded information while observing a format standard of the QR code defined by JBMIA (see FIG. 7). Namely, according to the present embodiment, more complex processing control can be performed based on a plurality of image codes. As a result of this, for example, it becomes possible to achieve processing based on complex conditions using the standard image code.

Further, it is also possible to treat the target page as the prohibited one in accordance with the value of the field 3 (operation level) included in the QR code in a device with which the specified vendor cannot be recognized. As a result of this, it becomes possible to prohibit information leakage.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-038826, filed Feb. 24, 2010, which is hereby incorporated by reference herein in its entirety.

What is claimed is:

1. An image processing apparatus comprising:
a unit configured to analyze a first image code included in an original document;
a unit configured to determine whether or not an analysis result of the first image code includes information indicating scanning prohibition;
a unit configured to analyze a second image code included in the original document if the analysis result of the first image code includes the information indicating scanning prohibition; and
a unit configured to, if an analysis result of the second image code includes information indicating a conditional scanning prohibition, permit scanning of the original document in accordance with a condition of the conditional scanning prohibition.

2. The image processing apparatus according to claim 1, wherein
the unit configured to analyze the second image code, if the analysis result of the first image code includes the information indicating scanning prohibition and also includes information indicating that the second image code is analyzed, analyzes the second image code.

3. The image processing apparatus according to claim 1, wherein
the unit configured to analyze the second image code, if the analysis result of the first image code includes the information indicating scanning prohibition and also includes information indicating a predetermined vendor, analyzes the second image code.

4. An image processing apparatus comprising:
a unit configured to analyze an image code included in image data;
a unit configured to determine whether or not an analysis result of the image code includes information indicating a predetermined vendor; and
a unit configured to switch processing to the image data depending on the determination result.

5. An image processing method comprising:
a step of analyzing a first image code included in an original document;
a step of determining whether or not an analysis result of the first image code includes information indicating scanning prohibition;
a step of analyzing a second image code included in the original document if the analysis result of the first image code includes the information indicating scanning prohibition; and
a step of, if an analysis result of the second image code includes information indicating a conditional scanning prohibition, permitting scanning of the original document in accordance with a condition of the conditional scanning prohibition.

6. A computer-readable recording medium having computer-executable instructions for performing a method, the method comprising:
a step of analyzing a first image code included in an original document;
a step of determining whether or not an analysis result of the first image code includes information indicating scanning prohibition;
a step of analyzing a second image code included in the original document if the analysis result of the first image code includes the information indicating scanning prohibition; and
a step of, if an analysis result of the second image code includes information indicating a conditional scanning prohibition, permitting scanning of the original document in accordance with a condition of the conditional scanning prohibition.
